(19) United States
(12) Patent Application Publication
(10) Pub. No.: US 2026/0243115 A1
(43) Pub. Date: Aug. 20, 2026

(54) VEHICLE LATCH ASSEMBLY

(71) Applicant: Ford Global Technologies, LLC, Dearborn, MI (US)

(72) Inventors: Daniel Trentin, Ivanhoe (AU); Stewart Marrogi, Broadmeadows (AU); Daniel Varricchio, Nunawading (AU)

(73) Assignee: Ford Global Technologies, LLC, Dearborn, MI (US)

(21) Appl. No.: 19/054,972

(22) Filed: Feb. 17, 2025

(51) Int. Cl. E05B 83/18; E05B 15/04; E05B 85/24

(52) U.S. Cl. CPC E05B 83/18; E05B 77/38; E05B 77/42; E05B 2015/0455

(57) ABSTRACT

A latch assembly for a vehicle has a latch body configured to be assembled on one of a moveable part on the vehicle and a fixed part on the vehicle. A latch is coupled to one of the latch body and a vehicle body and has a claw configured to latch onto a striker on the other of the moveable part and the fixed part in a latched position. A load spring is coupled to the latch body and configured to compress with force applied to the striker in the latched position.

### FIELD OF THE DISCLOSURE

The present disclosure generally relates to vehicle latches, and more particularly relates to a force loadable latch assembly that reduces rattle such as in a closure on a motor vehicle.

### BACKGROUND OF THE DISCLOSURE

Motor vehicles are commonly equipped with latches such as closure latches. For example, pickup trucks commonly have a tailgate at the rear end of the bed which includes a pair of latch assemblies on opposite lateral sides configured to engage a pair of strikers in the bed side wall at the rear end of the body of the vehicle to latch the tailgate in a closed position. To insure a snug fit and reduce movement, the latch assembly may include a rubber bump stop. It would be desirable to provide for a tailgate latch assembly which provides a preload force to reduce tailgate rattle with enhanced performance.

### SUMMARY OF THE DISCLOSURE

According to a first aspect of the present disclosure, a latch assembly for a vehicle has a latch body configured to be assembled on one of a moveable part on the vehicle and a fixed part on the vehicle. A latch is coupled to one of the latch body and a vehicle body and has a claw configured to latch onto a striker on the other of the moveable part and the fixed part in a latched position. A load spring is coupled to the latch body and configured to compress with force applied to the striker in the latched position.

Embodiments of the first aspect of the present disclosure can include any one or a combination of the following features:
the fixed part is a vehicle body, and the moveable part is a vehicle closure;
the vehicle closure is a tailgate;
the spring comprises a metal spring;
the metal spring comprises steel;
the spring has an arcuate shape configured to engage the striker and deform to provide a bias force;
a rigid support coupling the spring to the latch body;
the rigid support comprises nylon; and
the latch comprises the jaw and a pawl that holds the jaw in the latched position, and wherein the jaw is moved to an unlatched position in response to a user input.

According to a second aspect of the present disclosure, a vehicle tailgate includes a tailgate latch assembly having a latch body configured to be assembled on one of a tailgate of the vehicle and a fixed body part on the vehicle. A latch is coupled to the latch body and has a jaw configured to latch onto a striker on the other of the tailgate and the fixed body in a latched position. A load spring is coupled to the latch body and configured to compress with force applied to the striker in the latched position.

Embodiments of the second aspect of the present disclosure can include any one or a combination of the following features:
the spring comprises a metal spring;
the metal spring comprises steel;
the spring has an arcuate shape configured to engage the striker and deform to provide a bias force;
a rigid support coupling the spring to the latch body;
the rigid support comprises nylon; and
the latch comprises the jaw and a pawl that holds the jaw in the latched position, and wherein the jaw is moved to an unlatched position in response to a user input.

According to a third aspect of the present disclosure, a vehicle has a body generally defining a bed having a floor and first and second lateral side walls. First and second strikers are provided in the corresponding first and second lateral side walls at a rear end of the bed. A tailgate is pivotally coupled to a rear end of the body and moveable between a vertical closed position forming a rear wall of the bed and a downward horizontal position. First and second latch assemblies are provided on opposite lateral sides of the tailgate. The first and second latch assemblies have a latch body configured to be assembled on a tailgate of the vehicle. A latch is coupled to the latch body and has a jaw configured to latch onto a striker in a latched position. A load spring is coupled to the latch body and configured to compress with force applied to the striker in the latched position.

Embodiments of the third aspect of the present disclosure can include any one or a combination of the following features:
the latch assembly spring comprises a metal spring;
the metal spring comprises steel;
the latch assembly spring has an arcuate shape configured to engage the striker and deform to provide a bias force; and
a rigid support coupling the latch assembly spring to the latch body.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a rear upper perspective view of a motor vehicle configured as a pickup truck having a tailgate with a latch assembly, according to one embodiment;

FIG. 2 is an enlarged view of section II shown in FIG. 1 illustrating one of the latch assemblies on the tailgate in the closed tailgate position;

FIG. 3 is a cross-sectional perspective view of the latch assembly shown in FIG. 2 engaging a striker in the closed tailgate position;

FIG. 3A is a sideview of the cross-sectional view shown in FIG. 3 further illustrating the latch assembly engaging the striker in the closed tailgate position;

FIG. 4 is a cross-sectional perspective view of the latch assembly disengaged from the striker in a partially open tailgate position;

FIG. 4A is a sideview of the latch assembly shown in FIG. 4 with the latch assembly disengaged from the striker;

FIG. 5 is an enlarged perspective view of the load spring engaged on a rigid support of the latch assembly as shown on a first side; and

FIG. 6 is a perspective view of the load spring and rigid support shown in FIG. 5 on an opposite second side.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

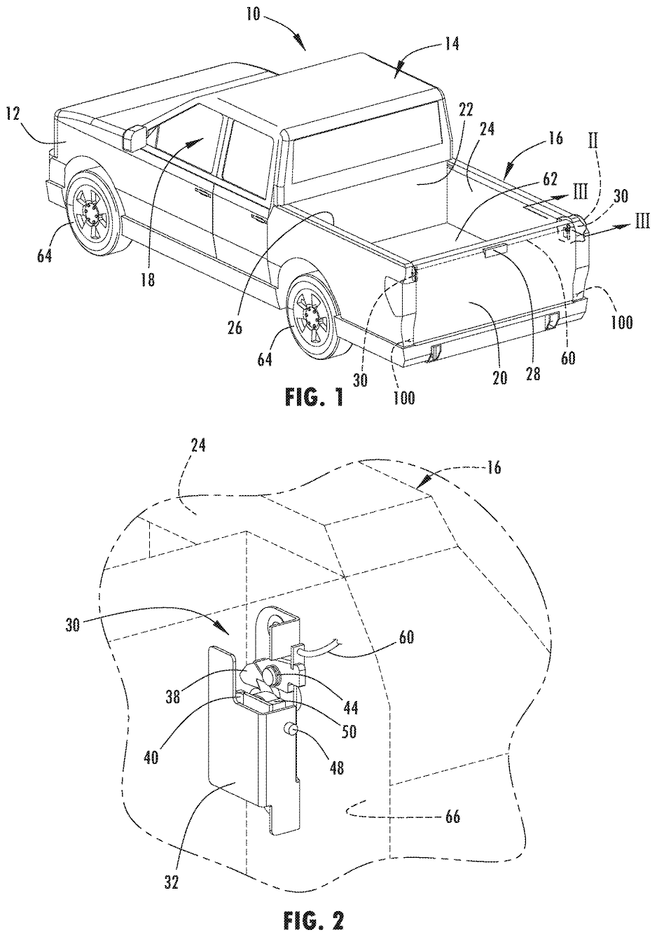

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a latch assembly for a motor vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1-6, a motor vehicle 10 in the form of a pickup truck is generally shown having a pair of vehicle latch assemblies 30 located in a tailgate 20 and configured to engage a pair of strikers 40 on opposite side walls at the rear end of the body 12 of the motor vehicle 10. The latch assembly 30 includes a latch body 32 configured to be assembled on one of a moveable part on the motor vehicle 10 such as on the tailgate 20 and a fixed part on the motor vehicle 10 such as a support on or connected to a body panel. A latch is coupled to the latch body 32 and has a claw configured to engage and latch onto a striker 40 on the other of the moveable part and the fixed part on the motor vehicle 10 in a latched position. The latch assembly 30 further includes a load spring 50 coupled to the latch body 32 and configured to compress with force applied to the striker 40 in the latched position.

The motor vehicle 10 shown in FIG. 1 is a wheeled automotive vehicle configured as a pickup truck that has a vehicle body 12 generally configured with a passenger cab 14 approximately located in the middle portion of the motor vehicle 10 and a bed 16 at the rear end portion of the motor vehicle 10. The passenger cab 14 generally defines a cabin interior 18 that typically includes a configuration of vehicle seating for holding vehicle occupants. The vehicle bed 16 at the rear end portion of the motor vehicle 10 has a bed floor 62, opposing left and right bed side walls 24 and 26, a front wall 22 proximate the front end of the bed 16 which is proximate a rear end of the passenger cab 14 and a rear bed wall provided by a tailgate 20 when in the closed position. The motor vehicle 10 is equipped with a plurality of tire and wheel assemblies 64.

The motor vehicle 10 includes the tailgate 20 pivotally coupled to the body 12 via a pair of pivot connectors 100 at a lower end at the rear end of the bed 16. The pivot connectors 100 may extend from the left and right bed side walls 24 and 26 and may be supported by support structures such as rear support pillars. The tailgate 20 is a closure which is a moveable part that may rotate and has a pair of latch assemblies 30 on opposite lateral sides of the tailgate 20 that are configured to engage a corresponding pair of strikers 40 provided at the rear end in the left and right bed side walls 24 and 26 of the bed 16. The strikers 40 may be supported by support structures such as rear support pillars. The latch assembly 30 is releasable by a latch release handle 28 centrally located on the upper outer surface of the tailgate 20 which enables a user to pull on the release handle 28 to pull release cables 60 to release the pair of latch assemblies 30 to allow the tailgate 20 to move from the closed vertical position to an open horizontal position that allows access to the bed 16 of the motor vehicle 10 from the rear end. It should be appreciated that the latch release handle 28 may be spring bias to the latched position and may be coupled to the first and second latch assemblies 30 via the pair of cables 60 extending on opposite sides.

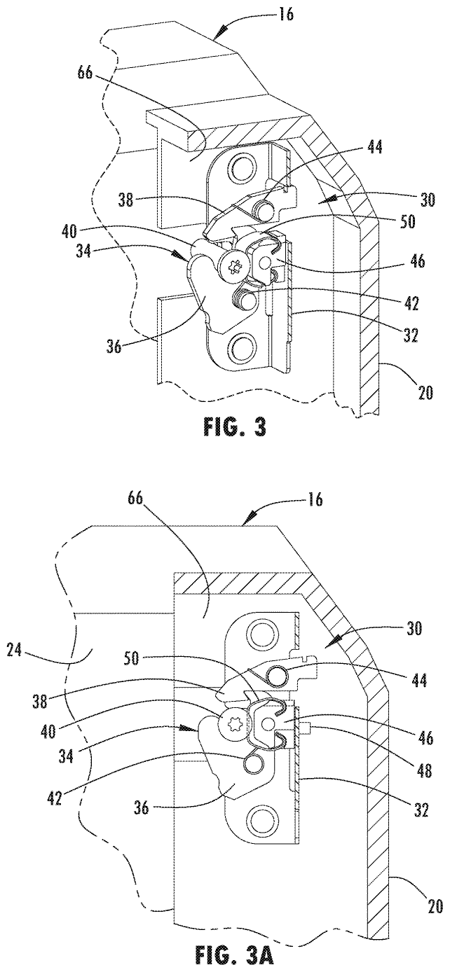

The latch assembly 30 is illustrated with the tailgate 20 in the upright closed position in FIGS. 2-3A. The latch assembly 30 includes the latch body 32 which is connected to a tailgate side wall 66 on the inner side of the tailgate 20 such as via fasteners, rivets, welding or other connectors. The latch body 32 generally has the latch components assembled thereon and supports the latch assembly 30 mounted onto the tailgate 20 in a position aligned to matingly engage a striker 40 which extends vehicle inward from an upper rear end of the side walls 24 and 26. The striker 40 is shown in one configuration as an elongated cylindrical rod having an enlarged head at the terminal end. It should be appreciated that the striker 40 may take the form of other shapes such as a U-shape and may be configured in other sizes.

The latch assembly 30 includes a jaw 36 on a lower portion and a pawl 38 on an upper portion, wherein the jaw 36 and pawl 38 are configured to engage and hold onto the striker 40 in the latched position. The jaw 36 includes a first latch spring 42 for biasing the jaw 36 towards the latched position. Similarly, the pawl 38 includes a second latch spring 44 biasing the pawl 38 to a locked pawl position engaging a tooth on a lock. When the tailgate 20 moves from the open position to the closed position to latch closed, the jaw 36 allows the striker 40 to pass over and engage within and be held by the jaw 36 and pawl 38 to maintain the striker 40 within the latch assembly 30 in the latched position. When a user pulls on the release handle 28 on the tailgate 20, the pawl 38 is actuated to move to an open position to release engagement of the jaw 36 with the striker 40 and allow the tailgate 20 to move from the closed position to the open position. It should be appreciated that the latch assembly 30 may be configured with alternative latching components that are different from the jaw and pawl arrangement shown according to other embodiments.

The latch assembly 30 is configured to include a load spring 50 that is coupled to the latch body 32 and configured to compress with force applied to the striker 40 in the latched position so as to reduce or minimize movement of the tailgate 20 and resulting rattle with the striker 40 or other body which may result from movement of the moveable tailgate 20 relative to the striker 40 and the fixed body of the motor vehicle 10. The load spring 50 is supported on a rigid support 46 which in turn is connected to the latch body 32 and has a portion 48 extending to the opposite side of the base plate 3. The rigid support 46 is sufficiently rigid such that it does not compress and may be made of a material such as nylon, for example, or metal according to another example. The load spring 50 has a shape and size configured to fit within the rigid support 46 and to abut and contact the striker 40 in the latched position and to provide a loaded spring bias force between the load spring 50 and the striker 40. It should be appreciated that the load spring 50 may otherwise be coupled to the latch assembly 30 such as directly connected to the latch body 32 or to other components such that the load spring 50 compresses with force applied to the striker 40 in the latched position according to other embodiments.

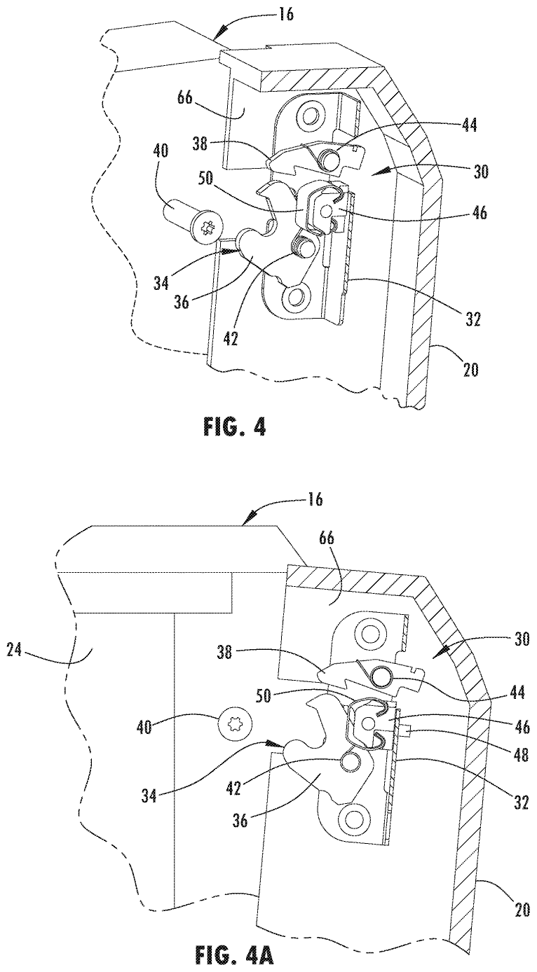

The latch assembly 30 is shown in FIGS. 4 and 4A with the latch assembly 30 in an open position and released and separated from the striker 40 as the tailgate 20 is moved from the closed position towards the open position. In this position, the tailgate 20 is free to move from the vertical closed position to the horizontal open position, and the load spring 50 no longer contacts the striker 40.

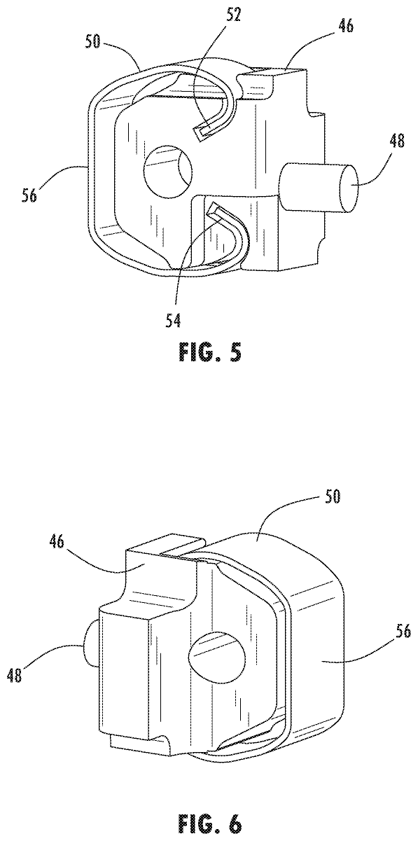

Referring to FIGS. 5 and 6, the load spring 50 is illustrated having a generally C-shape with a first spring end portion 52 and a second spring end portion 54 interconnected with an arcuate contact surface 56. The first and second spring end portions 52 and 54 may be inserted within a like shaped channel within the rigid support 46, according to one example. According to another example, the first and second spring end portions 52 and 54 may be molded into the rigid support 46. The load spring 50 may otherwise be supported on the latch assembly 30 according to other configurations. The load spring 50 may be configured as a metal spring, according to one embodiment. The metal load spring 50 may include steel, according to an example. According to another example, the metal load spring 50 may be made of carbon fiber. The arcuate portion 56 of the load spring 50 has a concave shape configured to engage the striker 40 in the latched position and to at least partially deform when compressed under force to provide a bias force load onto the striker 40 while the latch assembly 30 is in the latched position.

The latch assembly 30 may be assembled onto one of a moveable part on the motor vehicle 10 and a fixed part on the motor vehicle 10 for engaging a striker 40 located on the other of the moveable part of the motor vehicle 10 and the fixed part of the motor vehicle 10. In the example shown and described herein, the latch assembly 30 is provided on the moveable part shown configured as a tailgate 20 of the motor vehicle 10, and the striker 40 is shown provided on the fixed part which may include the support pillar on or proximate to the body 12 of the motor vehicle 10. It should be appreciated that the latch assembly 30 may otherwise be provided on the fixed part of the motor vehicle 10 to engage the striker 40 provided on the moveable part of the motor vehicle 10, according to other embodiments.

While the latch assembly 30 is shown and described herein for use in latching a tailgate 20 of a motor vehicle 10 onto a fixed support structure on or proximate the body 12 of the motor vehicle 10, it should be appreciated that the latch assembly 30 may be otherwise configured to latch other moveable parts to a fixed part on the motor vehicle 10. For example, the latch assembly 30 may be used for other closures, such as for latching a liftgate on a sport utility vehicle (SUV) in the closed position at the rear of the motor vehicle 10, or latching a side door of the motor vehicle 10 in a closed position, or latching a hood of the motor vehicle or a trunk of the motor vehicle in a closed position. It should further be appreciated that the latch assembly 30 may be useful for a motor vehicle 10 for latching a seat assembly, such as latching a seat back to a seat base and allowing the seat back to flip to a stowed position, and further for latching the seat base to an underlying support structure on the cabin floor to allow the seat to flip to a stowed position, such as a forward vertical position.

Accordingly, a latch assembly 30 for a motor vehicle 10 is provided that advantageously provides for a load spring 50 for applying a bias force onto a striker 40 so as to reduce or minimize movement of a moveable part such as the tailgate 20 relative to the fixed vehicle structure which may otherwise result in unwanted movement of the movable part and associated rattle noise. This may advantageously reduce the need for rubber bump stops and may offer an enhanced range of tolerances.

It is to be understood that variations and modifications can be made on the aforementioned structure without departing from the concepts of the present disclosure, and further it is to be understood that such concepts are intended to be covered by the following claims unless these claims by their language expressly state otherwise.

1. A latch assembly for a vehicle, the latch assembly comprising:
a latch body configured to be arranged on a moveable part of the vehicle;
a latch coupled to the latch body and having a jaw configured to latch onto a striker, configured to be arranged on a fixed part of the vehicle, in a latched position; and
a load spring coupled to the latch body and configured to compress with force applied to the load spring by the striker in the latched position of the jaw, wherein the load spring has a generally C-shape with first and second spring end portions connected to a rigid support and an arcuate portion between the first and second spring end portions that has a concave shape configured to engage the striker in the latched position.

2. The latch assembly of claim 1, wherein the fixed part is a vehicle body of the vehicle, and the moveable part is a vehicle closure of the vehicle.

3. The latch assembly of claim 2, wherein the vehicle closure is a tailgate.

4. The latch assembly of claim 1, wherein the load spring comprises a metal spring.

5. The latch assembly of claim 4, wherein the metal spring comprises steel.

6.-7. (Canceled)

8. The latch assembly of claim 7, wherein the rigid support comprises nylon.

9. The latch assembly of claim 1, wherein the latch comprises the jaw and a pawl that holds the jaw in the latched position, and wherein the jaw is moved to an unlatched position in response to a user input.

10. A vehicle tailgate comprising:
a tailgate latch assembly comprising:
a latch body configured to be arranged on the vehicle tailgate;
a latch coupled to the latch body and having a jaw configured to latch onto a striker, configured to be arranged on a fixed body part of the vehicle, in a latched position; and
a load spring coupled to the latch body and configured to compress with force applied to the load spring by the striker in the latched position of the jaw, wherein the load spring has a generally C-shape with first and second spring end portions connected to a rigid support and an arcuate portion between the first and second spring end portions that has a concave shape configured to engage the striker in the latched position.

11. The latch assembly of claim 10, wherein the load spring comprises a metal spring.

12. The latch assembly of claim 11, wherein the metal spring comprises steel.

13.-14. (canceled)

15. The latch assembly of claim 14, wherein the rigid support comprises nylon.

16. The latch assembly of claim 10, wherein the latch comprises the jaw and a pawl that holds the jaw in the latched position, and wherein the jaw is moved to an unlatched position in response to a user input.

17. A vehicle comprising:
a body generally defining a bed having a floor and first and second lateral side walls;
first and second strikers provided in the corresponding first and second lateral side walls at a rear end of the bed;
a tailgate pivotally coupled to a rear end of the body and moveable between a vertical closed position, forming a rear wall of the bed, and a downward horizontal position; and
first and second latch assemblies provided on opposite lateral sides of the tailgate, wherein each of the first and second latch assemblies comprising:
a latch body configured to be assembled on the tailgate of the vehicle;
a latch coupled to the latch body and having a jaw configured to latch onto a corresponding one of the first and second strikers in a latched position; and
a load spring coupled to the latch body and configured to compress with force applied to the load spring by a corresponding one of the first and second strikers in the latched position of the corresponding jaw of the first and second latch assemblies, wherein the load spring has a generally C-shape with first and second spring end portions connected to a rigid support and an arcuate portion between the first and second spring end portions that has a concave shape configured to engage the striker in the latched position.

18. The vehicle of claim 17, wherein the load spring comprises a metal spring, and wherein the metal spring comprises steel.

19.-20. (canceled)
